(19) United States
(12) Patent Application Publication
(10) Pub. No.: US 2014/0343992 A1
(43) Pub. Date: Nov. 20, 2014

(54) ADAPTIVE PUSH CALENDAR

(71) Applicant: SONY CORPORATION, Tokyo (JP)

(72) Inventors: Marvin DeMerchant, San Diego, CA (US); Norifumi Takaya, San Diego, CA (US); David Thiele, San Diego, CA (US)

(73) Assignee: SONY CORPORATION, Tokyo (JP)

(21) Appl. No.: 13/893,848

(22) Filed: May 14, 2013

(51) Int. Cl. G06Q 10/10

(52) U.S. Cl. CPC G06Q 10/1095
USPC 705/7.19

(57) ABSTRACT

An adaptive push calendar senses a user is in a vehicle and automatically looks up a calendar event, prompting the user as to whether the user wishes to have information presented pertaining to the calendar event. Based on the user's response the next prompt of a calendar even is modified to account for any additional information required by the user as part of responding to the first prompt.

### FIELD OF THE INVENTION

The present application relates generally to adaptively informing computer users of calendar events.

### BACKGROUND OF THE INVENTION

Electronically stored calendars are ubiquitous in modern computing devices. They can conveniently store a large number of upcoming events for a computer user's reference. As understood herein, however, most electronic calendars are simply computerized versions of conventional paper calendars, meaning that the user must access the calendar and scan through various entries until a sought after entry is located and its date ascertained. As also recognized herein, some calendar events may be more important to one user than to another and the importance can vary depending on the user's current activity.

### SUMMARY OF THE INVENTION

An apparatus includes a computer readable storage medium that is not a carrier wave and that is accessible to a client processor of a client device and bearing instructions which when executed by the client processor configure the processor to execute logic to execute a method that includes, responsive to receiving a first position signal, displaying a first prompt on a computer about a calendar event. The method executed by the processor includes recording a user response to the first prompt, and based at least in part on the response and responsive to subsequently receiving a position signal, generating a second prompt about a calendar event different from the first prompt such that the second prompt is modified from the first prompt based on the user response to the first prompt.

In some embodiments the first position signal indicates that a user of the apparatus is in a vehicle. The first position signal can be received from a global positioning satellite (GPS) receiver, or it can be established by the processor pairing with a wireless transceiver in the vehicle.

The processor may cause the prompt to be presented on a vehicle display.

In example implementations, the first and second position signals can indicate identical locations, the first and second prompts can each indicate a first type of event, but based on the user response to the first prompt the second prompt is different than the first prompt.

In another aspect, an apparatus includes a computer readable storage medium that is not a carrier wave and that is accessible to a client processor of a wireless computer device (WCD) and bearing instructions which when executed by the client processor configure the processor to execute logic to execute a method that includes determining that the WCD is in a vehicle responsive to establishing communication between the WCD and vehicle. The processor, responsive to determining that the WCD is in a vehicle, accesses an electronically stored calendar to return a first event, displays a name of the first event, and receives a user response to the display of the event. Also, the processor accesses the calendar to return a second event, displays a name of the second event, and along with displaying the name of the second event, displays a portion of the user response to the first event.

In another aspect, a method includes adaptively pushing electronically stored calendar information to a user of a wireless communication device (WCD) responsive to the WCD sensing it is in a vehicle. The adaptively pushing includes automatically looking up a calendar event and prompting the user as to whether the user wishes to have information presented pertaining to the calendar event. Based on a user response to the prompting, a next prompt of a next calendar is altered such that the next prompt is modified to account for the user response.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system according to present principles;

FIG. 2 is a flow chart of example overall logic;

FIG. 3 is a flow chart of example logic for an exemplary use case;

FIG. 4 is a flow chart of example logic for proactively providing weather and traffic information along a route to a calendar event;

FIG. 5 is a flow chart of example logic for proactively assisting a user to decide whether to call ahead if late for an appointment;

FIG. 6 is a flow chart of example logic for proactively calling ahead in conference mode if late for a particular type of appointment

### DETAILED DESCRIPTION OF THE PREFERRED EMBODIMENT

Disclosed are methods, apparatus, and systems for computer based user information. A system herein may include server and client components, connected over a network such that data may be exchanged between the client and server components. The client components may include one or more computing devices. These may include personal computers, laptops, tablet computers, and other mobile devices including smart phones. These client devices may operate with a variety of operating environments. For example, some of the client computers may be running Microsoft Windows® operating system. Other client devices may be running one or more derivatives of the Unix operating system, or operating systems produced by Apple® Computer, such as the MS® operating system, or the Android® operating system, produced by Google®. While examples of client device configurations are provided, these are only examples and are not meant to be limiting. These operating environments may also include one or more browsing programs, such as Microsoft Internet Explorer®, Firefox, Google Chrome®, or one of the other many browser programs known in the art. The browsing programs on the client devices may be used to access web applications hosted by the server components discussed below.

Server components may include one or more computer servers executing instructions that configure the servers to receive and transmit data over the network. For example, in some implementations, the client and server components may be connected over the Internet. In other implementations, the client and server components may be connected over a local intranet, such as an intranet within a school or a school district. In other implementations a virtual private network may be implemented between the client components and the server components. This virtual private network may then also be implemented over the internet or an intranet.

The data produced by the servers may be received by the client devices discussed above. The client devices may also generate network data that is received by the servers. The server components may also include load balancers, firewalls, caches, and proxies, and other network infrastructure known in the art for implementing a reliable and secure web site infrastructure. One or more server components may form an apparatus that implement methods of providing a secure community to one or more members. The methods may be implemented by software instructions executing on processors included in the server components. These methods may utilize one or more of the user interface examples provided below in the appendix.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as the AMD® Athlon® II or Phenom® II processor, Intel® i3®/i5®/i7® processors, Intel Xeon® processor, or any implementation of an ARM® processor. In addition, the processor may be any conventional special purpose processor, including OMAP processors, Qualcomm® processors such as Snapdragon®, or a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. The description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be written in any conventional programming language such as C#, C, C++, BASIC, Pascal, or Java, and run under a conventional operating system. C#, C, C++, BASIC, Pascal, Java, and FORTRAN are industry standard programming languages for which many commercial compilers can be used to create executable code. The system may also be written using interpreted languages such as Pert Python or Ruby. These are examples only and not intended to be limiting.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a, computer-readable medium. Computer-readable media include both computer storage media and communication media including any medium that facilitates transfer of a computer program from one place to another. However, a computer readable storage medium is not a carrier wave, and may be any available media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.) It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting.

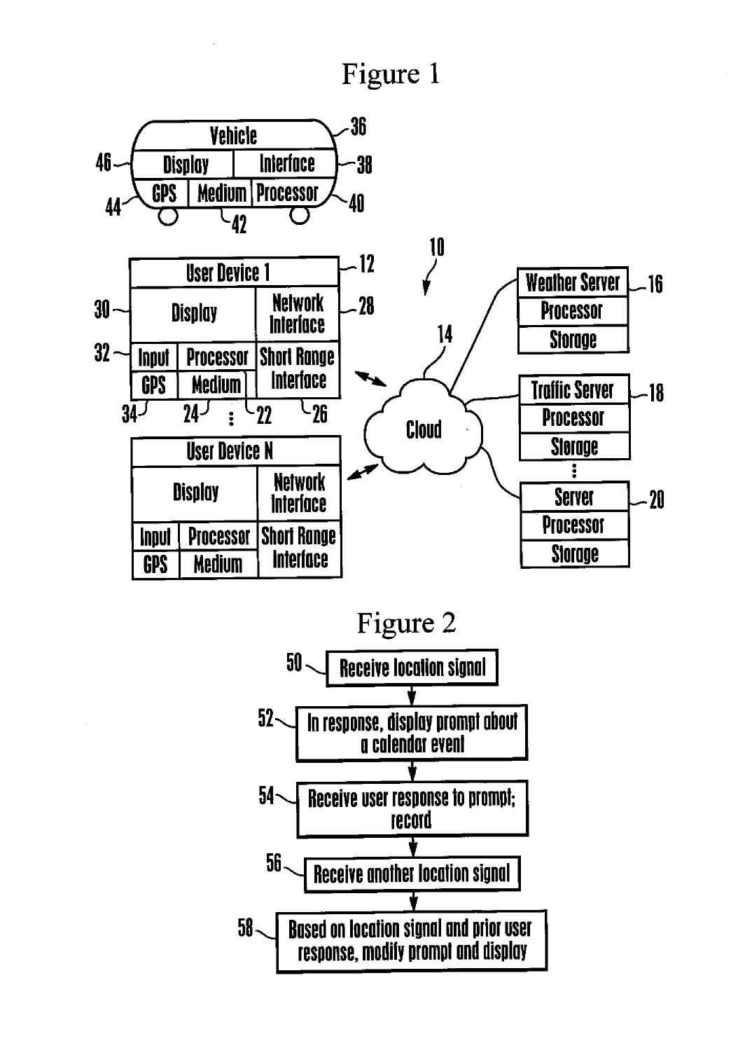

Referring initially to FIG. 1, a system 10 includes at least one and in the example shown “N” user or client devices 12 communicating via a computer cloud 14 such as the Internet with one or more server computers. In the example shown, a weather server 16, a traffic server 18, and in general one or more servers 20 communicate with the client device 12 through the cloud.

Among the non-limiting and example components a client device 12 may incorporate, a processor 22 accesses a computer readable storage medium 24 that contains instructions which when executed by the processor configure the processor to undertake principles disclosed below. The client device 12 may communicate with other client devices using a wireless short range communication interface 26 such as but not limited to a Bluetooth transceiver controlled by the processor 22. Also, the client device 12 may communicate with the cloud 14 using a wireless network interface 28 such as but not limited to one or more of a WiFi transceiver, wireless modem, wireless telephony transceiver, etc. controlled by the processor 22. Wired interfaces 26, 28 are also contemplated.

The client device typically includes a visual display 30 such as a liquid crystal display (LCD) or light emitting diode (LED) display or other type of display controlled by the processor 22 to present demanded images. The display 30 may be a touch screen display. In addition, one or more input devices 32 may be provided for inputting user commands to the processor 22. Example input devices include keypads and keyboards, point-and-click devices, a microphone inputting voice commands to a voice recognition engine executed by the processor 22, etc. A position sensor 34 may input signals to the processor 22 representing a location of the client device 12. While FIG. 1 assumes that the position receiver 34 is a global positioning satellite (GPS) receiver, other position sensors may be used in addition or in lieu of a GPS receiver. For example, a motion sensor 35 such as an accelerometer, gyroscope, magnetic sensor, and the like may be used to input position information to the processor 22. Location information may also be derived from WiFi information, e.g., the location of the client device may be inferred to be the location of a WiFi hotspot in which the device is communicating.

FIG. 1 also shows that a person carrying the client device 12 may decide to enter a vehicle 36. The vehicle 36 may include a communication interface 38 controlled by a vehicle processor 40 accessing a computer readable storage medium 42. The interface 38 may be configured to communicate with one of the interfaces of the client device 12 and may be a Bluetooth transceiver. The vehicle 36 may include an onboard GPS receiver 44 or other position receiver sending signals to the processor 40 representing the location of the vehicle 36. The vehicle processor 40 may control a visual display 46 in the vehicle to, e.g., present an electronic map thereon and other user interfaces. Other client devices may be transported by their users into other vehicles and establish communication with the processors of the other vehicles.

FIG. 2 shows overall example logic. Commencing at block 50, a user device 12, which can be a wireless communication device (WCD), receives a location signal. The location signal can be from the GPS receiver 34, or it can be established by the WCD 12 pairing with the processor 32 in the vehicle 36 using, e.g., Bluetooth pairing or WiFi communication establishment or other pairing method.

Moving to block 52, in response to the location signal the processor 22 of the WCD 12 accesses the storage medium 24 to retrieve calendar information, which contains data on events or appointments of the user of the WCD 12 along with date and time information pertaining to the events. The WCD 12 presents a prompt about an event responsive to the location signal received at block 50. The prompt may be audible and/or visual, and if desired the WCD 12 may send the prompt to the vehicle processor 42 to cause the prompt to be presented on the vehicle display 46 or vehicle speakers in addition to or in lieu of presenting the prompt on the WCD 12.

Proceeding to block 54, a user response to the prompt is received and recorded on, e.g., the storage medium 24. Subsequently, another location signal is received at block 56 and based on both the user's prior response to the previous prompt and the location signal received at block 56, the prompt is modified from what it had been at block 52 and displayed at block 58. Note that the location signals received at blocks 50 and 56 may indicate identical locations, e.g., they may both indicate the same GPS location or the same “in the vehicle” location. Note further that the event prompted at block 52 may be the same type of event prompted at block 58, e.g., “meeting with Dave”. Nonetheless, based on the user's response to the first prompt at block 54, the second prompt at block 58 is different than the first prompt at block 52.

To give an example, suppose that based on determining that the WCD 12 is in the vehicle 36 owing to making a Bluetooth pairing with the vehicle processor 42, the WCD processor 22 accesses a calendar and notes that the meeting is scheduled for one hour in the future at a location thirty miles from the present location as indicated by, e.g., the GPS receiver 34. The distance determination may be made by the processor inputting an address of the event listed in the calendar into a map application, inputting its current location into the map application, and using the map application to find the distance.

In any case, the processor infers that the user may be driving to the event. The prompt at block 52 may be, “you have a meeting in an hour”. If the user responds to the prompt by asking into a microphone connected to the processor 22 “where” as recognized by a voice recognition module, the processor accesses the calendar and responds with the address listed in the calendar. Then suppose the next day the WCD 12 once again is co-located in the vehicle (block 56) and the calendar indicates a meeting an hour in the future, thirty miles distant. The modified prompt at block 58 can be “you have a meeting in an hour” followed by a display of the address of the meeting without having to be asked a second time, owing to the user's response received at block 54 to the first prompt displayed at block 52.

Note further that while the above example uses only a single user response to modify a prompt, in some embodiments the same response must be received two or more times before modifying a prompt.

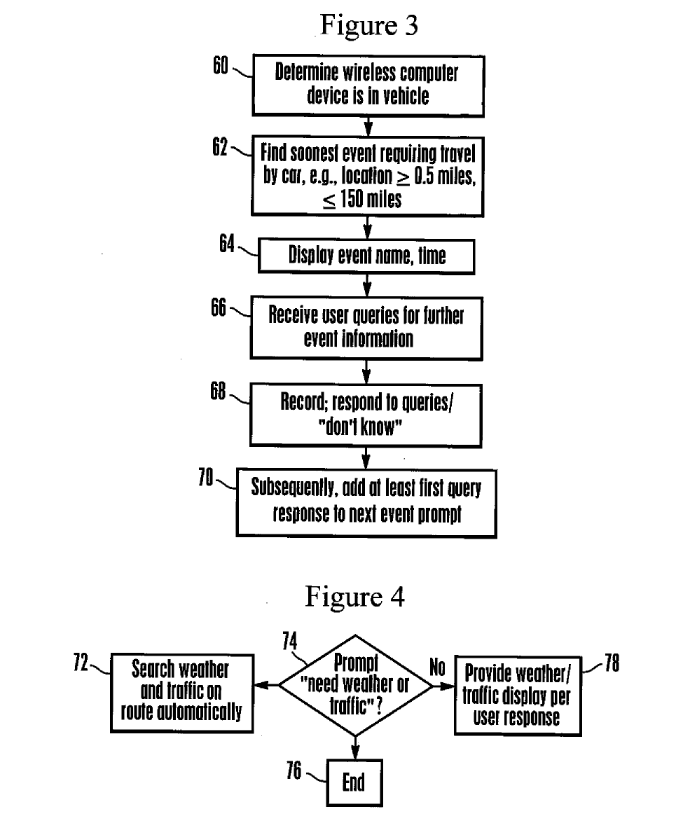

FIG. 3 illustrates a specific use case of the above principles as an example. At block 60 the processor 22 determine it is in the vehicle 36, so it moves to block 62 to locate the soonest calendar event which can be inferred to require travel by vehicle. In one example this determination is made if the event location is greater than a minimum distance, e.g., greater than a hundred yards or a half mile or other minimum threshold, and less than a maximum distance, e.g., less than one hundred fifty miles or other maximum threshold. If the soonest event does not fall within the band the next soonest event is tested, and so on until an event is found which satisfies the thresholds.

Proceeding to block 64, the name of the event output from block 62 and the time of the event is displayed, and as discussed above this display may be audible and/or visual and it may be presented on the WCD 12 and/or vehicle 36. At block 66 user information for further event information is received and recorded at block 68, with the WCD responding to the request by accessing the calendar or other data structure to find the requested information and returning “don't know” if the information cannot be found. At block 70, the response generated at block 68 (assuming the requested information was successfully found and presented) is added to the information displayed for the next event that is prompted.

FIG. 4 shows that in addition to the above, the WCD 12 can also proactively push further information to the user that might be useful. For example, weather and traffic websites can be searched at block 72 automatically by the WCD 12 along the route from the present location to the location of the event that was the subject of the logic of FIG. 2 or 3. After collecting weather and/or traffic information, in the example shown the information is not displayed but instead the WCD simply prompts the user, audibly and/or visually, if the user wants to see or hear weather and/or traffic information at decision diamond 74. If the user enters (as by speaking) a response of “no”, the logic ends at state 76. However, if the user responds “yes” the weather and/or traffic information is presented at block 78 per the user response. For example, the user might respond “yes, traffic only” in which case only traffic information is presented. Note that if the user enters as by speaking the word “silence” or equivalent, the above proactive prompting is suspended.

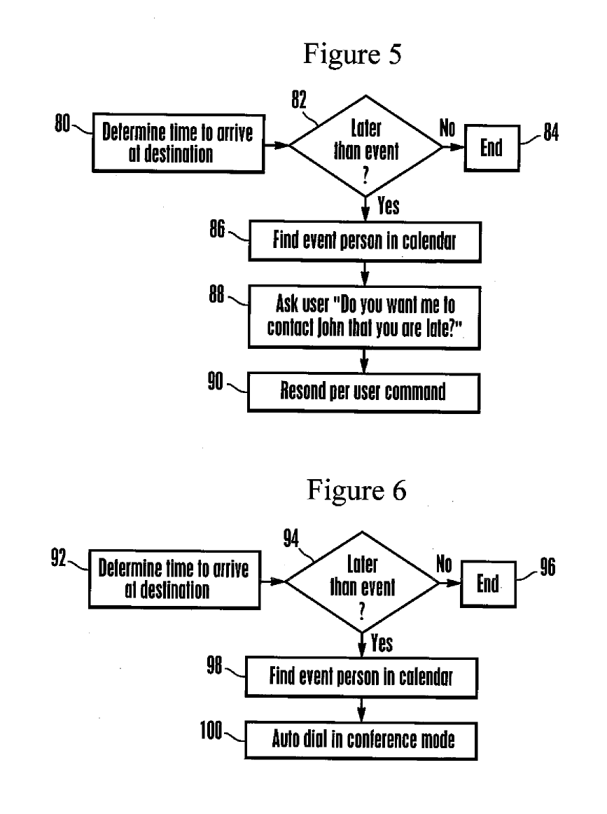

FIGS. 5 and 6 show additional proactive logic that can be used to assist a user while traveling. Commencing at block 80 in FIG. 5, having determined an event to which the user is driving the WCD 12 can automatically determine a time to arrive at the destination of the event. This may be done by accessing a map application with the current location input as the “from” location and the event location input as the “to” location. The map application typically returns directions and travel time, which may be modified based on inclement weather or heavy traffic.

The travel time is added to the current time and then compared to the event time in the calendar at decision diamond 82. If the event time is later than the travel time, the logic can end at state 84. Otherwise, the logic moves to block 86 on the assumption that the user will be late for the event and determines if a person is associated with the event. If a person is associated with the event the person's telephone number, email address, or other communication number is located and at block 88 the WCD can audibly and/or visually ask the user if the user would like to use the WCD to contact the person located at block 86. The WCD responds to the user command at block 90 appropriately. For instance, if the user returned “no” the WCD 12 would do nothing more to contact the person. If the user returned “yes” the WCD 12 dials the person or prepares an automatic email or text message to the person that indicates the user will be late, if desired including an estimate of the user's arrival time.

Note that in example embodiments the above logic can select the person to be notified and how the contact is made as follows. The logic can automatically identify the meeting organizer listed in the calendar as the person to contact with “running late” message. Also, using machine learning, the logic can determine the mode in which to contact the meeting organizer, e.g., by text message, email, phone call, etc., based on previous contact methods that have been used. The UI presented to the user may list the mode to inform the user prior to sending the message, allowing the user to override the established method via voice or touch input and command another mode to be used. In addition, the logic can also compare the meeting members listed in the calendar with the user's contact history to order the alternative meeting members in a list presented on a UI by who the user has contacted the most and how.

FIG. 6 shows logic similar to that of FIG. 5 but with even more automated proactivity on the part of the WCD 12. Commencing at block 92 in FIG. 6, having determined an event to which the user is driving the WCD 12 can automatically determine a time to arrive at the destination of the event. This may be done by accessing a map application with the current location input as the “from” location and the event location input as the “to” location. The map application typically returns directions and travel time, which may be modified based on inclement weather or heavy traffic.

The travel time is added to the current time and then compared to the event time in the calendar at decision diamond 94. If the event time is later than the travel time, the logic can end at state 96. Otherwise, the logic moves to block 98 on the assumption that the user will be late for the event and determines if a person is associated with the event. If a person is associated with the event the person's telephone number, email address, or other communication number is located, at block 100 the person is automatically contacted by automatically dialing the person's phone, in conference mode if desired, or by preparing an automatic email or text message to the person that indicates the user will be late, if desired including an estimate of the user's arrival time.

Thus, a calendar system is disclosed that pushes information to the user based on an intelligent analysis of the current time, the user's current location, and the location of the appointment which can be verified based on prior meetings in a similar location and/or user verification. In addition to scheduling conflicts, the user is alerted to conflicts associated with being in a present location that might prevent the user from making his next appointment taking into consideration an estimated travel time. Travel time estimates can be made based on a determination of whether the user is currently in his car, real-time traffic, posted speed limits on a best rote, displaying the best route and directions to the meeting, and the option to alert any or all meeting attendees of a delayed arrival time.

While the particular ADAPTIVE PUSH CALENDAR is herein shown and described in detail, it is to be understood that the subject matter which is encompassed by the present invention is limited only by the claims.

What is claimed is:

1. Apparatus comprising:
at least one computer readable storage medium that is not a carrier wave and that is accessible to a digital processor and bearing instructions which when executed by the processor configure the processor to execute logic to execute a method comprising:
responsive to receiving a first position signal, displaying a first prompt on a computer about a calendar event;
recording a user response to the first prompt;
based at least in part on the response and responsive to subsequently receiving a position signal, generating a second prompt about a calendar event different from the first prompt such that the second prompt is modified from the first prompt based on the user response to the first prompt.

2. The apparatus of claim 1, wherein the first position signal indicates that a user of the apparatus is in a vehicle.

3. The apparatus of claim 2, wherein the first position signal is received from a global positioning satellite (GPS) receiver.

4. The apparatus of claim 2, wherein the first position signal is established by the processor pairing with a wireless transceiver in the vehicle.

5. The apparatus of claim 1, wherein the processor causes the prompt to be presented on a vehicle display.

6. The apparatus of claim 1, wherein the first and second position signals indicate identical locations, the first and second prompts each indicate a first type of event, but based on the user response to the first prompt the second prompt is different than the first prompt.

7. Apparatus comprising:
at least one computer readable storage medium that is not a carrier wave and that is accessible to a digital processor of a wireless communication device (WCD) and bearing instructions which when executed by the processor configure the processor to execute logic to execute a method comprising:
determining that the WCD is in a vehicle responsive to establishing communication between the WCD and vehicle;
responsive to determining that the WCD is in a vehicle, accessing an electronically stored calendar to return a first event;
displaying at least a name of the first event;
receiving a user response to the displaying of at least a name of the first event;
accessing the calendar to return a second event;
displaying at least a name of the second event; and
along with displaying at least a name of the second event, displaying at least a portion of the user response to the first event.

8. The apparatus of claim 7, wherein the first event is returned based on being a soonest event with a location from a present location of the WCD that is greater than a minimum threshold distance and less than a maximum threshold distance.

9. The apparatus of claim 7, wherein the method executed by the processor accessing the computer readable storage medium further includes:
without user command, automatically obtaining and presenting weather and/or traffic information related to the first event.
without user command, automatically obtaining and presenting traffic information related to the first event.

10. The apparatus of claim 7, wherein the method executed by the processor accessing the computer readable storage medium further includes:
without user command, automatically determining a time to arrive at the first event;
determining whether the time to arrive at the first event is later than a time of the first event;
at least in part responsive to a determination that the time to arrive at the first event is later than the time of the first event, presenting a prompt to a user of the WCD asking if the user wants to send a message that the user will be late.

11. The apparatus of claim 7, wherein the method executed by the processor accessing the computer readable storage medium further includes:
without user command, automatically determining a time to arrive at the first event;
determining whether the time to arrive at the first event is later than a time of the first event;
at least in part responsive to a determination that the time to arrive at the first event is later than the time of the first event, without user command sending, to a recipient, a message that the user will be late.

12. The apparatus of claim 10, wherein the method executed by the processor accessing the computer readable storage medium further includes:
responsive to a determination that the time to arrive at the first event is later than the time of the first event, determining whether a person other than the user is associated with the event; and
responsive to a determination that a person other than the user is associated with the event, presenting a prompt to the user asking if the user wishes to send a message to the person.

13. A method comprising:
adaptively pushing electronically stored calendar information to a user of a wireless communication device (WCD) responsive to the WCD sensing it is in a vehicle, the step of adaptively pushing including:
automatically looking up a calendar event;
prompting the user as to whether the user wishes to have information presented pertaining to the calendar event; and
based at least in part on a user response to the prompting, altering a next prompt of a next calendar such that the next prompt is modified to account for the user response.

14. The method of claim 13, comprising:
determining that the WCD is in a vehicle responsive to establishing communication between the WCD and vehicle;
responsive to determining that the WCD is in a vehicle, accessing an electronically stored calendar to return a first event;
displaying at least a name of the first event;
receiving a user response to the displaying of at least a name of the first event;
accessing the calendar to return a second event;
displaying at least a name of the second event; and
along with displaying at least a name of the second event, displaying at least a portion of the user response to the first event.

15. The method of claim 13, wherein the event is returned based on being a soonest event with a location from a present location of the WCD that is greater than a minimum threshold distance and less than a maximum threshold distance.

16. The method of claim 13, comprising:
without user command, automatically obtaining and presenting weather information related to the first event.

17. The method of claim 13, comprising:
without user command, automatically obtaining and presenting traffic information related to the first event.

18. The method of claim 13, comprising:
without user command, automatically determining a time to arrive at the event;
determining whether the time to arrive at the first event is later than a time of the event;
at least in part responsive to a determination that the time to arrive at the event is later than the time of the event, presenting a prompt to a user of the WCD asking if the user wants to send a message that the user will be late.

19. The method of claim 13, comprising:
without user command, automatically determining a time to arrive at the event;
determining whether the time to arrive, at the first event is later than a time of the event;
at least in part responsive to a determination that the time to arrive at the event is later than the time of the event, without user command sending, to a recipient, a message that the user will be late.

20. The method of claim 13, comprising:
responsive to a determination that the time to arrive at the event is later than the time of the event, determining whether a person other than the user is associated with the event; and
responsive to a determination that a person other than the user is associated with the event, presenting a prompt to the user asking if the user wishes to send a message to the person.
